(19) United States
(12) Patent Application Publication
(10) Pub. No.: US 2010/0079456 A1
(43) Pub. Date: Apr. 1, 2010

(54) Method for determining a 3D surface approaching the object boundary of an object in a digital 3D data set

(75) Inventor: Karl Barth, Hochstadt (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT

(21) Appl. No.: 12/585,978

(22) Filed: Sep. 30, 2009

(30) Foreign Application Priority Data
Oct. 1, 2008 (DE) 10 2008 050 049.6

(51) Int. Cl. G06T 17/00

(52) U.S. Cl. 345/424

(57) ABSTRACT

A method is disclosed for determining a 3D surface approaching the object boundary of an object in a digital 3D data set. In at least one embodiment, the method includes splitting up the 3D data set into contiguous 3D part areas of voxels. Then, in each 3D part area, a measure of probability for the presence of the object boundary in this 3D part area, as well as a potential position and orientation of the object boundary, are determined. Thereafter, in each 3D part area, the measure of probability is investigated with reference to an edge criterion as to whether the object boundary runs in the 3D part area, and from a set of surface sections given for the 3D area, that section is selected that most closely approximates to the position and orientation of the object boundary. Finally, the 3D surface is formed as the union of sets of the selected surface sections.

### PRIORITY STATEMENT

The present application hereby claims priority under 35 U.S.C. §119 on German patent application number DE 10 2008 050 049.6 filed Oct. 1, 2008, the entire contents of which are hereby incorporated herein by reference.

### FIELD

At least one embodiment of the invention generally relates to a method for determining a 3D surface approaching the object boundary of an object in a digital 3D data set.

### BACKGROUND

In many areas of non-destructive, non-invasive measurement and test technology, e.g. in medical imaging within the framework of diagnostics, it is normal nowadays to generate a digital three-dimensional image data set of objects under examination, e.g. of a patient. Such an image data set, also called a volume scan, is a closed voxel block, i.e. a three-dimensional voxel block completely filled with voxels. In the graphical imaging of such a voxel block it should however be possible to view points within the volume.

A known method for doing this is volume rendering (VR). Volume rendering makes possible a direct visualization, also called direct volume rendering, and as a rule delivers a transparent or semi-transparent representation of the overall voxel block with floating, i.e. generally unsharp, structure or object transitions. In other words a “cloudy glass”-like view into the depth of the volume block is possible in this way. Object boundaries of an image of an object recorded in the volume block however are not clearly shown with the volume rendering method. This task is specifically the object of the so-called Shaded Surface Display (SSD) method. SSD requires that points (voxels) on the 3D surface of part objects be determined and marked within the 3D volume and that only these voxels then be displayed. The determination of such surface points (surface voxels) within a volume block is generally referred to as segmentation.

In a first known variant, to do this, in a first step associated volume elements which are to be assigned in accordance with their measured value to one and the same object type (bone) in each case, i.e. voxels, are identified and each marked in the same way. Thus marked part volumes are produced in the 3D data set which essentially correspond to the volume of the objects. In medical tomographic images the measured value can be the bone-specific density value for example, if bony objects are to be segmented. In a second step all edge points of each part volume or object are then determined. Such edge points are those marked points which possess at least one adjacent point which is assigned to another object or to the object environment (so-called background voxel).

In an alternate variant all edge points are determined directly, i.e. without determining the voxels belonging to the volume of the object. This occurs for example by using a gradient operator in conjunction with a threshold value, since a suitable gradient operator delivers high signal values at the points at which a transition from object to environment/background is present. The segmented object volume can then, in the converse manner to the previous variant, be determined as the totality of all voxels enclosed by the edge points.

With pure segmentation however no relationship between the voxels is established, i.e. it is not clear which marked voxels are adjacent to each other in each case, and thus it is also not known for example how many self-contained objects are to be found in the voxel block. With SSD representation too there is always a certain graduation of the surface, especially when the information is presented with reduced resolution, e.g. when small voxel blocks of for example 8 (2×2×2) or 27 (3×3×3) voxels are grouped together for presentation in each case.

For many requirements and applications a surface presentation as meshes of a net which coalesce with each other at the segmented surface voxels, is thus better suited. Preferably it is the nodes of these meshes which define the local surface positions and which produce from the positions the surface voxels identified in the segmentation. The net meshes can be any type of polygon (triangles, rectangles, polygons).

In the case of triangles as mesh elements the calculation of the net display is referred to as “triangulation”. In a last step the visualization of the surface network is undertaken, e.g. taking into consideration suitable coloring, illumination and orientation of the respective surface elements in relation to observer and light source.

The surface representation or description in net form (meshes) has the advantage over VR and SSD that the adjacency of its elements is clear and the surface thus displayed has a continuous course. This means that the objects shown can be clearly contoured in conjunction with suitable coloring and shadowing and can be imaged with optimum surface quality. This is possible since for surface processing or presentation outlay generally only occurs which increases with the square of the surface. With a given computing capacity relatively high outlay can be expended in this way for fine modeling of each surface element.

If the surface of the object is clearly defined or determined, the calculations, e.g. in order to establish the contact between different objects in order to prevent collisions in other applications, to change objects or to group objects together, can be undertaken significantly more easily, reliably and quickly. The memory requirement within a computer, e.g. a medical workstation for the two-dimensional surface or its processing or handling in 3D images in net representation is also far lower than with the above-mentioned direct volume presentation, such as with volume rendering for example or with Shaded Surface Display.

A part of the known segmentation method is oriented initially to individual 2D layers which are captured in turn from the 3D volume data set, and initially determines in the 2D layers 2D outlines of the sought objects. The 2D contours found are subsequently assembled using all involved layers of the voxel block to a 3D contour.

Direct 3D segmentation methods do actually behave better isotropically than the above layer methods. Previously known direct 3D segmentation methods which operate directly on the voxel block in original resolution, i.e. the entire data volume, have the problem however in this case that the computing or search effort which must be carried out during the segmentation in all 3 spatial directions is considerable.

In many cases a better structured description of the original 3D image data set is thus first generated in order to reduce the computation outlay. Often a hierarchical structuring of the volume is needed, e.g. so-called octrees or octtrees are formed—possibly in a number of layers. In these cases 8 voxels in each case which possess a common corner are grouped together, so that after an execution of the method, the entire volume of the 3D image data is represented with half resolution per axis. This leads to an eighth of memory requirement and correspondingly reduced computing effort if a segmentation method is undertaken initially on a 3D image data set with coarser resolution. The full resolution is able to be restored however if the “coarse” segmentation undertaken in the coarse resolution is eventually refined to the higher resolution needed.

With many of the known methods the objects, part objects or surfaces or the voxels belonging to them are determined with reference to threshold values. To this end a threshold value is first defined. Voxels with values which correspond precisely to this threshold value are to represent the transition of the object to the environment, i.e. they are surface points. Voxels with higher values lie within the object for example, those with lower values lie outside the object. This exclusive dependence on threshold values is a great disadvantage, specifically with medical imaging data. In many cases it cannot be assumed that there is a constant signal level within the 3D volume and also within the object. E.g. the voxel values change in magnetic resonance tomography with increasing distance from the receive coil. Voxels which really belong to one and the same object can thus have different values. Furthermore all threshold value methods are susceptible to faults or noise in the volume data. Faults and noise can in particular frequently occur with medical data sets e.g. because of the x-ray noise or generally the signal noise—in magnetic resonance tomography or ultrasound. Such noise has direct effects on a threshold-value-based definition. Faults show up for example by there being gaps in the resulting surfaces, because there are many interruptions in the neighborhood of the surface elements, i.e. “holes” in the surface.

### SUMMARY

At least one embodiment of the invention specifies an improved method for determining 3D surfaces which approach the object boundaries of objects in a digital 3D data set.

At least one embodiment is directed to a method for determining a 3D surface approaching the object boundary of an object in a digital 3D data set, with the following steps: In a step a) the 3D data set is broken down into contiguous 3D part areas of voxels. Each 3D part area is thus a seamless contiguous part voxel block. The size of the part voxel block in this case comprises at least two voxels in each of the three spatial directions and in this case is significantly smaller—i.e. a hundredth through to a thousandth—than the extent of the 3D data set (3D voxel block) in the corresponding spatial direction.

In a step b) a measure of probability for the presence of the object boundary in this 3D part area as well as a potential position and orientation of the object boundary is determined in each 3D part area. Compound values, e.g. in the form of matrices or vectoral variables from the voxel values, are determined as the measure of probability, which also allow a measure for estimating the presence of an object boundary, e.g. the strength of the voxel value change. In each case the potential position (if one is available) and orientation of the potential object boundary is determined as a precautionary measure.

In a step c) in each 3D part area the values of the voxels in their entirety in the form of a measure of probability are examined with reference to an edge criterion as to whether the object boundary or a part of this boundary actually runs in the present 3D part area. In other words the 3D data set is not searched voxel-by-voxel but by area to find the object boundary. To this end, or to determine the measure of probability and from the position and orientation of the object boundary, numerical computations are created which essentially deliver continuous values for the properties of the object boundary, e.g. voxel values, value statistics, surface orientation, color transition and/or strength of the characteristic of the object boundary.

In step c) a decision is thus made as to whether the 3D part area just examined actually contains a surface section of the object boundary, and this 3D part area is assigned the position and orientation determined in step b). Else this 3D part area is not considered any further.

If the object boundary actually runs in this 3D part area, in an optional embodiment of the method more refined values for describing and presenting the object boundary in the 3D part area can be determined once again here, e.g. their position, local course and alignment are determined more precisely.

In a step d) in this case that section of the surface is selected from a set of sections of the surface given for the 3D part area which most closely approximates to the position and/or orientation of the object boundary. In other words not just any individual surface section in the 3D area, a part thereof or its environment are fitted in, but only a limited set of “sample surfaces” is available, from which a matching surface section will be selected.

In a step e) the 3D surface is then formed as a union of sets of all found or selected surface sections, as explained above.

The search using part areas instead of voxel-by-voxel means that during the detection of the object boundary, compared to known methods, a smoothing, filtering or compensation for local individual voxel errors is undertaken. Overall the object boundary determination is undertaken with fewer faults. In the inventive method the search is thus not undertaken point-by-point—voxel-by-voxel—for the object boundary, but in the 3D part areas, i.e. in local environments of the individual voxels actually to be investigated. In other words the environment has a diameter of n points with 2≦n<<N, if N is the diameter of the 3D data set.

By using a set of given surface elements a further smoothing of the object surfaces is undertaken. The set of surface elements can for example be selected so that the surface arising can only follow naturally occurring curvatures of the object, but cannot follow voxel errors, artifacts and the like and thus smoothes these out.

At least one embodiment of the inventive method thus improves the known threshold value method which is used to determine the object boundary, which above all with noisy input data and/or non-reliable signal levels represents a gain. Problems in known segmentation methods which arise at this point—through an incorrect determination of the object boundary—are eliminated in the inventive method.

Steps a) through c) at least one embodiment of the inventive method thus represent a low-noise and reliable determination of the course of the object boundary in the 3D data set. Steps d) and e) likewise form a new or improved method for forming the 3D surface or in other words for allocating particular surface sections to the object boundary. The surface sections provided, which are available for selection for this purpose, each possess their own normal vector.

In accordance with the orientation of the normal vector of the object boundary in the corresponding 3D part area determined, that section of the surface is thus selected from the restricted set of surface sections, of which the normal vector most closely approaches the determined normal vector of the actual object boundary. The set of surface sections is selected here so as to allow the surface to be expected to be fully covered.

The method makes it possible to also determine a number of 3D (part) surfaces at once. Thus the method allows a number of bone fragments and organs to be segmented simultaneously in a medical image data set.

In an example embodiment of the method in step b) in the 3D part area a 3D gradient based on the values of the voxels is formed as the measure of probability for example. In other words in the local environment—the 3D area—of an actual voxel to be investigated a three-dimensional gradient is determined in the core of the 3D area, which thus also takes account of adjacency points, namely all voxels in the 3D area and thus delivers a more tendential, smoothed or filtered measure for the presence of the object boundary. An edge criterion is then applied to the 3D gradient with which a decision is made as to whether a 3D surface (edge) actually runs through the 3D part area or not. If not, no further consideration is given to this 3D part area.

In an alternate variant of at least one embodiment of the method, in step c) the amount of the 3D gradient is checked with reference to a threshold value as edge criterion. Because of the filtering or smoothing effects or mechanisms described above the use of a threshold value in this case if far less critical than with the known methods of a threshold value applied directly to the voxel values and leads to more reliable and thereby more precise information about the course of the object boundary or its presence in a 3D part area.

An especially reliable smoothing in the determination of the gradient is undertaken in a variant of the method in which in step b) first in the 3D part area in each of the three spatial directions for each voxel level at an angle to the respective spatial direction an average value of the values of the voxel is formed. The gradient is then formed from the average values. In other words for example to determine the gradient in the x direction, the n voxel measuring 3D part area is divided up into n y-z voxel planes which lie one behind the other in the x direction. In each y-z direction one of n average values of the voxel values are formed. The x gradient is then calculated from the values of the n-tuple of the n average values extending in the x direction. The gradient values thus determined in all three spatial directions are assembled into a 3D gradient in the form of a vector.

In the event of determining a corresponding gradient vector as 3D gradient, in a further variant of the method, in step c), the orientation of the object boundary can be steplessly determined as the direction of the 3D gradient.

In an alternate embodiment of the method, in step b) an edge pattern for the object boundary can also be defined for the 3D part area to be investigated. The edge pattern in this case corresponds to the relative course of the voxel values which is expected for an edge transition from object to background. A measure of similarity between the—possibly averaged—values of the voxels in the 3D part area and the edge pattern is then subsequently determined as the measure of probability. The edge criterion is then applied in step c) to the measure of similarity.

The edge pattern is thus defined in advance as how the relative course of voxel values perpendicular to the object boundary sought is typically to be expected In other words a suitable conversion of all adjacency points of a central voxel in the 3D part area, i.e. all voxels of the 3D part area with a typical sought edge pattern. In this case there is good fault suppression, i.e. noise suppression for all 3D surface points or 3D edge points which describe the object boundary in the 3D data set.

Here too, in a variant of at least one embodiment of the invention, the measure of similarity can be checked as an edge criterion with reference to a threshold value.

In an example variant of at least one embodiment of the method in step a) cuboids with edge lengths of at least 2 voxels are selected as 3D part areas. By selecting cuboids or especially cubes the entire 3D data set can easily be subdivided into individual 3D areas which seamlessly fill the 3D data set.

In an example embodiment of the invention, adjacent cuboids are then overlaid in each of the three spatial directions by at least one voxel plane. In other words the voxel plane of the one 3D area forming one side surface of a rectangle then simultaneously belongs to the adjacent 3D area or also forms its side surface. In a correspondingly voxel-precise adaptation of surface elements in the 3D areas seamlessly adjoining entire surfaces are thus formed if the intersection lines of the surface sections have the same coverage as the cuboid boundaries at two adjacent 3D areas.

In at least one embodiment of the inventive method however, it can still occur that gaps or an offset between surface sections of adjacent 3D part areas arise in the 3D surface. Therefore, in an example embodiment of the method, after step e) non-adjacent surface sections of neighboring 3D part areas are adapted to each other by interpolation. The gap closure is undertaken for example at the edge or at corner point positions of the 3D part areas at right angles to the main normal direction of the unsuitable surface sections. The main normal direction is the direction of the largest components of the local direction or normal vector or the surface elements.

At points at which despite all improvements of the method, discontinuities (jumps) have remained, a surface section is modified on at least one side of such a jump in its position and/or orientation or another surface section is selected. A table holds information about which combination of two surface sections are permissible in such cases.

In a variant of at least one embodiment of the method on at least one side of the mismatch and the adjoining surface sections a section other than the available surface section(s) is (are) selected. The table holds information about which combination of two surface sections is permissible in such cases.

Gaps occurring in the 3D surface can also be closed in a further variant of at least one embodiment of the invention after step e) by inserting additional interpolated surface sections between adjoining surface sections.

### BRIEF DESCRIPTION OF THE DRAWINGS

For a further description of the invention the reader is referred to the example embodiments of the drawings. Each of the figures is a basic schematic diagram as follows:

FIG. 1 a 3D data set of a patient with division into 3D areas.

FIG. 2 a 3D area from FIG. 1 in detail,

FIG. 3 the calculation of the gradients in the 3D area from FIG. 2,

FIG. 4 the 3D area from FIG. 2 with a set of surface sections,

FIG. 5 the closing of a mismatch or of a gap in the 3D surface by interpolation.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

MOW Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

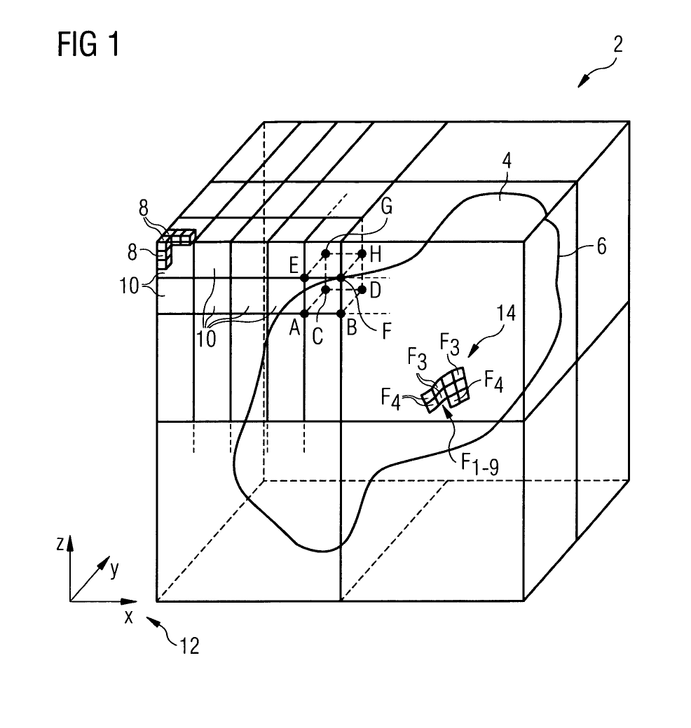

FIG. 1 shows a 3D data set 2 in which the liver of a patient is mapped as an object 4. The 3D data set 2 involves a Dicom volume block which was recorded within the framework of medical imaging. In the 3D data set 2 the surface, i.e. the object boundary 6 of the object 4, is to be segmented. The 3D data set 2 consists of a plurality of voxels 8.

In a first step the 3D data set 2 is split up into 3D part areas 10. The totality of all 3D part areas 10 thus forms the complete 3D data set 2. Each 3D part area 10 in this case contains a plurality of voxels 8. For further explanations the 3D data set 2 is assigned a coordinate system 12 with axes in the spatial directions x, y, z.

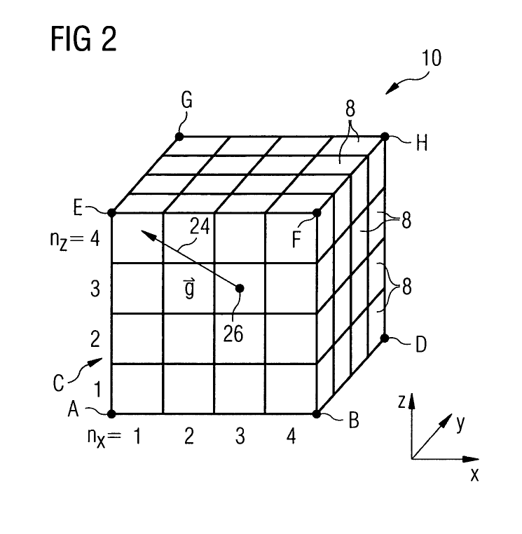

FIG. 2 shows one of the 3D part areas from FIG. 1 in detail which, in the x, y and z direction respectively, comprises n=4 voxels in each case. The 3D part area is thus a cube of a total of 4×4×4=64 voxels 8. The 3D part area 10 also possesses 8 corner points A through H.

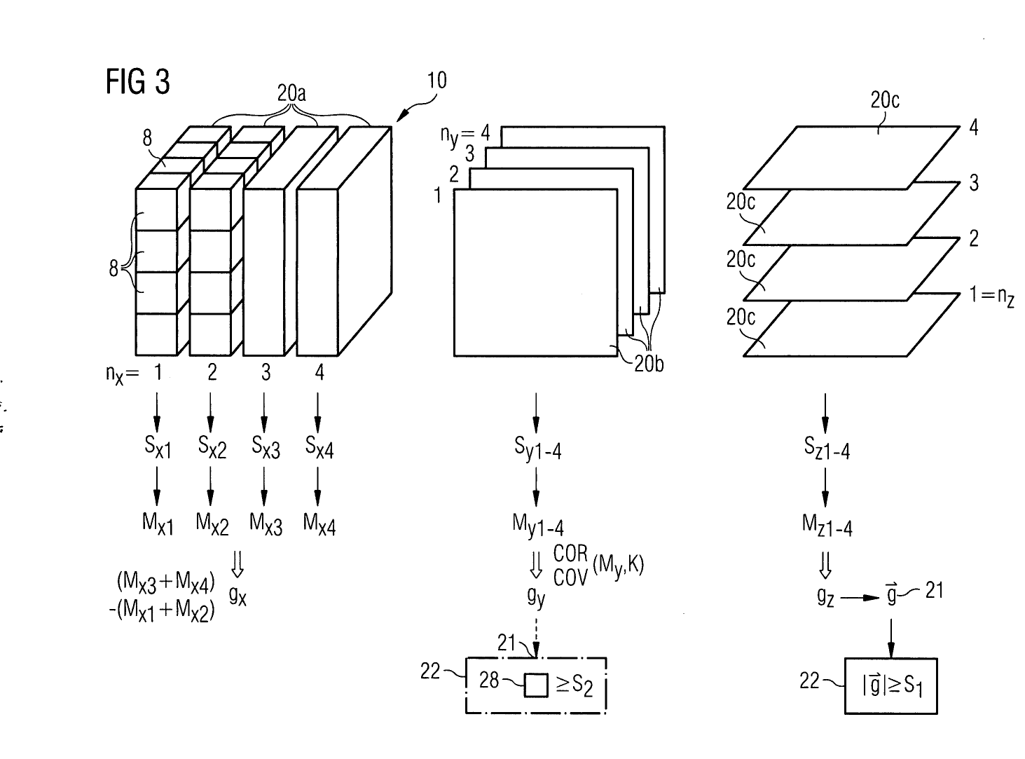

Subsequently each of the 3D part areas 10 will now be examined in turn for the presence of the object boundary 6 in the respective 3D area 10. FIG. 3 shows how, for this purpose in a first substep the 3D area 10 is divided up into a number of nₓ=4 voxel planes 20a extending in the y-z plane. In each voxel plane 20a of nₓ=1−4 the 16 respective voxels of the voxel plane of layer 20a involved are summed to form a sum S_{X1-4} and then averaged to form an average value Mx₁₋₄. From the respective average values Mₓ₁₋₄ a gradient gₓ is subsequently formed, which thus delivers information about the course of the averaged voxel values within the 3D part area 10 along the spatial direction x.

The same is done in accordance with FIG. 3 in further substeps for the spatial directions y and z in the 3D part area 10. From four voxel planes 20b and 20c in each case in the spatial directions y and z sums Sy1-4 and Sz1-4, average values My1-4 and Mz1-4 and gradients g_{y} and g_{z} are formed accordingly. Finally from the gradients g_{x-z} as components the 3D gradient g̅ is formed as a vector. The 3D gradient g̅ represents a measure of the probability 21 of the presence of the object boundary (6) in 3D part areas.

The amount of the 3D gradient g̅, | g̅| represents a measure of whether a part of the object boundary 6 runs in the 3D area 10. In the form of an edge criterion 22 the amount of the 3D gradient | g̅| is thus compared with a threshold value S1.

Numerous options exist for forming the gradients g_{x-z}, e.g. gₓ to Mₓ₃+Mₓ₄−Mₓ₁−Mₓ₂ is determined as a difference. Alternatively the gradient gy can also be determined for example in the form of a correlation to COR(M_{y1-4}, K). K in this case is an edge pattern which reflects a course of voxel values or the change to be expected if the object boundary 6 runs in the 3D part area 10. In the present case K is for example (100, 50, −50, −100) in accordance with four average values My1-4 to be expected (normalized) for the presence of an object boundary 6 in the 3D part area 10. The operator COR forms the correlation coefficient. Alternatively the covariance operator COV can also be used for example. In the last two cases the operators form a measure of similarity 28 between the edge pattern K and the values of the voxels 8 in the 3D area 10. The measure of similarity 28 is an alternate measure of probability 21.

Here the measure of similarity 28 is then subsequently checked against a threshold value S₂ in order to determine whether a part of the object boundary 6 runs in the 3D part area.

If the threshold values S1 or S2 are exceeded, the object boundary 6 is detected locally in the 3D part area 10, otherwise not. In the case of the 3D part area of FIG. 2 a positive detection results. The vector direction of the 3D gradient g̅ then specifies which orientation 24 the object boundary possesses in the 3D part area 10. The position 26 of the 3D part area 10 (or of its center) in 3D data set 2 specifies the location of the local object boundary 6.

In all 3D part areas 10 in which an object boundary 6 is detected the object boundary 6 should now be approached by surface elements.

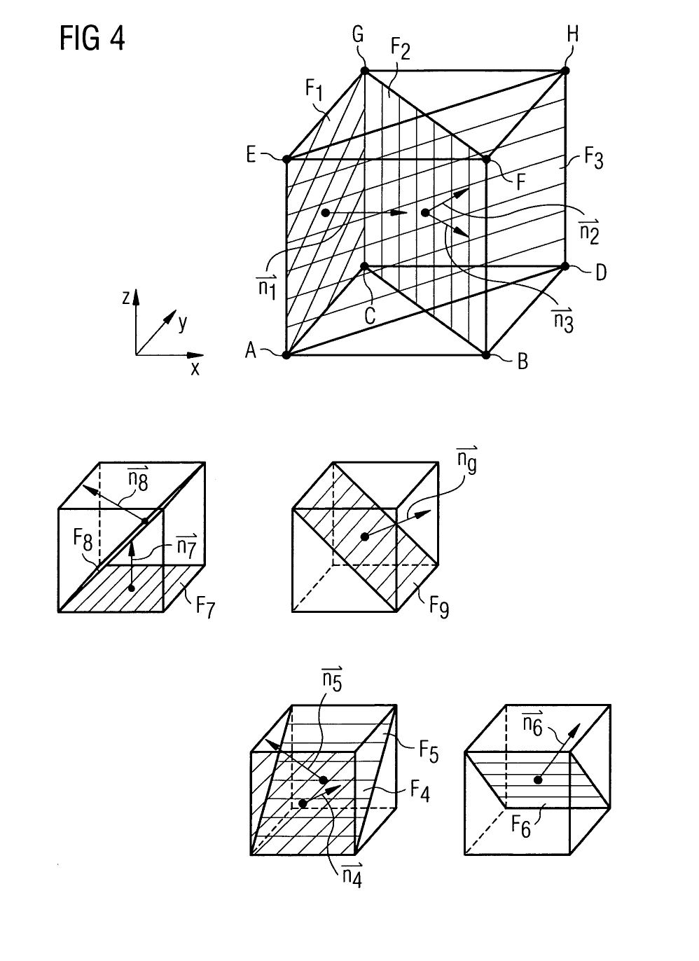

To this end, FIG. 4 again shows the 3D part area 10 with its corner points A-H. For the 3D part area 10 a set of a total of 9 surface elements F₁₋₉ is now generated, of which each possesses a normal vector n̅₁₋₉. E.g. the surface element F1 possesses between the corner points ACGE the normalized normal vector (1,0,0). The surface element F2 between BCGF the normalized normal vector (1/\sqrt{2},1/\sqrt{2},0) and the surface element F₃ between ADHE the normalized normal vector (1/\sqrt{2},−1/\sqrt{2},0). The three surface elements F₁₋₃ are also called x-dominated surface elements, since their main orientation runs in the direction of the x-axis. In a similar way to that explained above, FIG. 4 also shows the y-dominated surface F₄₋₆ and the z-dominated surface elements F₇₋₉.

For the case in which in one of the 3D part areas the threshold value S1 or S2 is exceeded, that surface element is selected from the set of nine surface elements F₁₋₉ of which the normal vector n̅₁₋₉ most closely approaches the 3D gradient g̅ in relation to its orientation. The location of the surface element is determined by the location 26.

After the method has been executed for all 3D part areas 10 of the 3D data set 2, the correspondingly selected surface elements F₁₋₉ together form a 3D surface 14 which roughly approximates to the object boundary 6. FIG. 1 symbolically shows a section of the 3D surface 14.

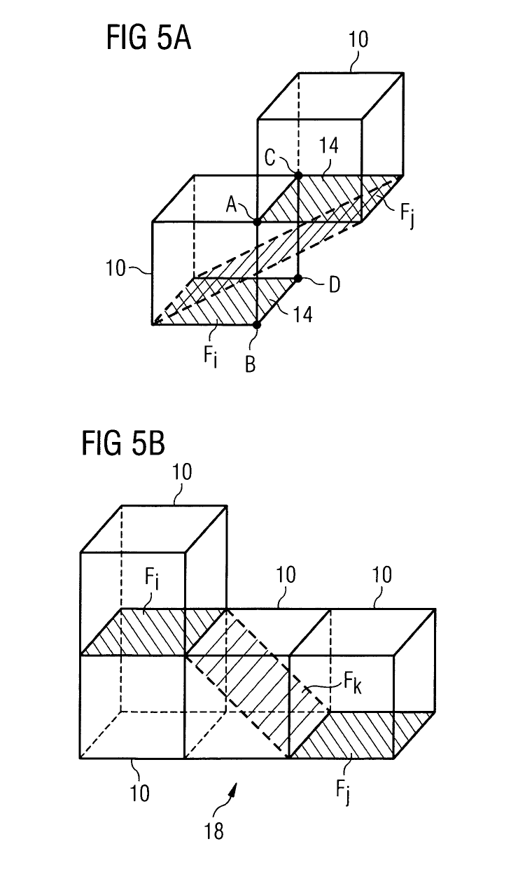

FIG. 5a shows a situation after completion of the 3D surface 14, whereby this is not closed because of signal noise, since in the two 3D part areas 10 shown the surface elements Fᵢ and Fⱼ do not butt against each other. To close the 3D surface 14 an interpolation of the surface elements Fᵢ and Fⱼ and thus of the 3D surface 14 is thus carried out between the corresponding points A and C and B and D of the 3D part areas 10.

FIG. 5b shows a further case which occurs when a third area (marked by an arrow 18) exists between two 3D part areas which has incorrectly not been assigned any surface element. Thus, in the 3D area 10 involved, after conclusion of the actual segmentation method, an appropriate element of the surface elements Fₖ is selected which connects the cross-hatched already determined surface elements Fᵢ and Fⱼ by interpolation, in other words closes the gaps arising.

### LIST OF REFERENCE SYMBOLS

2 3D data set
4 Object
6 Object boundary
8 Voxel
10 3D area
12 Coordinate system
14 3D surface
18 Arrow
20a-c Voxel plane
22 Edge criterion
24 Orientation
26 Position
x,y,z spatial direction
n_{x,y,z} Number
A-H Corner point
S_{x-z,1-4} Sum
M_{x-z,1-4} Average value
g_{x-z} Gradient
g̅ 3D gradient
S1,2 Threshold value
F_{1-9,i,j,k} Surface element
n̅₁₋₉ Normal vector
K Edge pattern

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for forming a 3D surface approaching an object boundary of an object in a digital 3D data set, the method comprising:
splitting up the digital 3D data set into contiguous 3D part areas of voxels;
determining, in each 3D part area, a measure of probability for a presence of the object boundary in the respective 3D part area, and determining a potential position and orientation of the object boundary;
investigating, in each 3D part area, the determined measure of probability with reference to an edge criterion as to whether the object boundary runs in the respective 3D part area;
selecting, from a set of surface sections given for the 3D area, a section that most closely approximates to the position and orientation of the object boundary; and
forming the 3D surface as a union of sets of the selected surface sections.

2. The method as claimed in claim 1, wherein the determining includes:
forming, in the 3D part area, a 3D gradient of the values of the voxels as the measure of probability; and
applying the edge criterion to the 3D gradient.

3. The method as claimed in claim 2, wherein, in the investigating, the magnitude of the 3D gradient is checked as the edge criterion with reference to a threshold value.

4. The method as claimed in claim 2, wherein the determining includes:
forming, in the 3D area, in each of the three spatial directions for each voxel plane transverse to the respective spatial direction, an average value of the values of the voxels; and
forming the 3D gradient from the average values.

5. The method as claimed in claim 2, wherein the determining includes:
determining the orientation of the object boundary as a direction of the 3D gradient.

6. The method as claimed in claim 1, wherein the determining includes:
defining an edge pattern for the object boundary as a measure of probability for the 3D area, and
determining a measure of similarity between the values of the voxels in the 3D area and the edge pattern; and wherein in the investigating, the edge criterion is applied to the measure of similarity.

7. The method as claimed in claim 6, wherein in the investigating, the measure of similarity is checked with reference to the threshold value as an edge criterion.

8. The method as claimed in claim 1, wherein the splitting up includes selecting cuboids with edge lengths of at least two voxels as 3D areas.

9. The method as claimed in claim 8, wherein the splitting up includes overlaying an adjacent 3D area in each of the three spatial directions by at least one voxel plane in each case.

10. The method as claimed in claim 1, wherein after the forming, surface sections which do not adjoin each other of neighboring 3D areas are adapted to each other by interpolation.

11. The method as claimed in claim 1, wherein, after the forming, a gap in the 3D surface is closed by an additionally inserted and interpolated surface section.

12. The method as claimed in claim 1, wherein, after the forming, a gap in the 3D surface is closed by exchanging surface sections in accordance with a table of permitted adjacencies of surface sections to other surface sections for the set of permitted neighbors.

13. The method as claimed in claim 3, wherein the determining includes:
forming, in the 3D area, in each of the three spatial directions for each voxel plane transverse to the respective spatial direction, an average value of the values of the voxels; and
forming the 3D gradient from the average values.
